(19) United States
(12) Patent Application Publication
(10) Pub. No.: US 2002/0113814 A1
(43) Pub. Date: Aug. 22, 2002

(54) Method and device for video scene composition

(76) Inventors: Guillaume Brouard, Paris (FR); Thierry Durandy, Issy les Moulineaux (FR); Thierry Planterose, Paris (FR)

Correspondence Address: U.S. Philips Corporation, 590 White Pains Road, Tarrytown, NY, 10591, US

(21) Appl. No.: 10/082,861

(22) Filed: Oct. 19, 2001

(30) Foreign Application Priority Data
Oct. 24, 2000 (EP) 00402938.5

(51) Int. Cl. H04N 5/445

(52) U.S. Cl. 345/723; 725/39

(57) ABSTRACT

The invention relates to a cost-effective and optimized method of composing a scene content from digital video data streams containing video objects, said method comprising a decoding step for generating decoded object frames from said digital video data streams, and a rendering step for composing intermediate-composed frames in a composition buffer from said decoded object frames. The method of scene composition according to the invention comprises a scaling step applied to said intermediate-composed frames for generating output frames constituting scene content. Indeed, by performing a scaling step on intermediate-composed frames of the final scene, enlarged frames are obtained in a single processing step, which considerably reduces the computational load. The use of a signal co-processor for the scaling step provides a possibility of anticipating simultaneously the decoding of objects, performed by a signal processor, used in the composition of the future intermediate-composed frame. Use: Video scene compositor

The present invention relates to a method of composing a scene content from digital video data streams containing video objects, said method comprising a decoding step for generating decoded object frames from said digital video data streams, and a rendering step for composing intermediate-composed frames in a composition buffer from said decoded object frames.

This invention may be used, for example, in the field of digital television broadcasting and implemented as an Electronic Program Guide (EPG) allowing a viewer to interact within a rendered video scene.

The MPEG-4 standard, referred to as ISO/IEC 14496-2, provides functionality for multimedia data manipulation. It is dedicated to scene composition containing different natural or synthetic objects, such as two-or three-dimensional images, video clips, audio tracks, texts or graphics. This standard allows scene content creation usable and compliant with multiple applications, allows flexibility in object combination, and offers means for users-interaction in scenes containing multiple objects. This standard may be used in a communication system comprising a server and a client terminal via a communication link. In such applications, MPEG-4 data exchanged between the two sets are streamed on said communication link and employed at the client terminal to create multimedia applications.

The international patent application WO 00/01154 describes a terminal and method of the above kind for composing and presenting MPEG-4 video programs. This terminal comprises:

a terminal manager for managing the overall processing tasks,

decoders for providing decoded objects,

a composition engine for maintaining, updating, and assembling a scene graph of the decoded objects,

a presentation engine for providing a scene for presentation.

It is an object of the invention to provide a cost-effective and optimized method of video scene composition. The invention takes the following aspects into consideration.

The composition method according to the prior art allows the composition of a video scene from a set of decoded video objects. To this end, a composition engine maintains, updates, and assembles a scene graph of a set of objects previously decoded by a set of decoders. In response, a presentation engine retrieves a video scene for presentation on output devices such as a video monitor. Before rendering, this method allows to convert decoded objects individually into an appropriated format. If the rendered scene format must be enlarged, a converting step must be applied to all decoded objects from which the scene is composed. This method thus remains expensive since it requires high computational resources and since the complexity of threads management is increased.

To solve the limitations of the prior art method, the method of composing a scene content according to the invention is characterized in that it comprises a scaling step applied to said intermediate-composed frames for generating output frames constituting scene content.

Indeed, by performing a scaling step on intermediate-composed frames of the final scene, enlarged frames are obtained in a single processing step, which considerably reduces the computational load.

The method of scene composition according to the invention is also characterized in that said method is intended to be executed by means of a signal processor and a signal co-processor performing synchronized and parallel tasks for creating simultaneously current and future output frames from said intermediate-composed frames. Thus, the scaling step of a current intermediate-composed frame is intended to be performed by the signal co-processor while the decoding step generating decoded object frames used for the composition of the future intermediate-composed frame is intended to be performed simultaneously by the signal processor.

The use of a signal co-processor for the scaling step provides a possibility of anticipating the decoding of objects used in the composition of the future intermediate-composed frame: object frames used in the composition of the future intermediate-composed frame can even be decoded during the composition of the current output frame. This multi-tasking method allows a high processing optimization, which leads to faster processing, as those skilled in the art will appreciate when dealing with real-time applications.

These and other aspects of the invention will be apparent from and elucidated with reference to the embodiments described hereinafter.

The particular aspects of the invention will now be explained with reference to the embodiments described hereinafter and considered in connection with the accompanying drawings, in which identical parts or sub-steps are designated in the same manner:

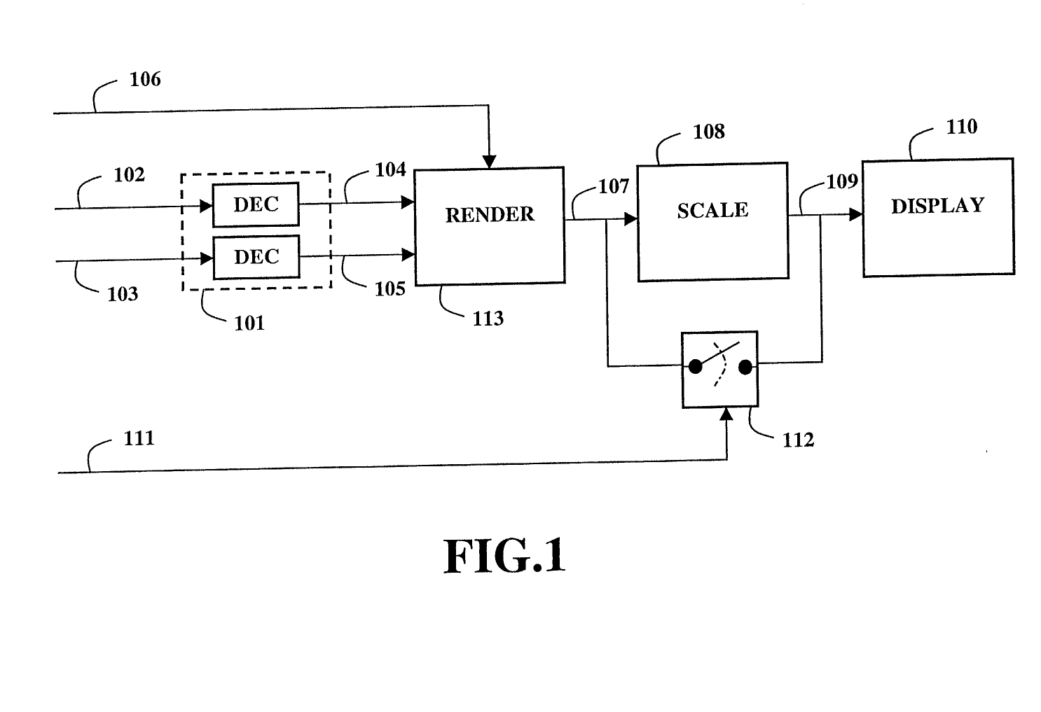

FIG. 1 depicts a block diagram representing a terminal dedicated to a video scene composition according to the invention,

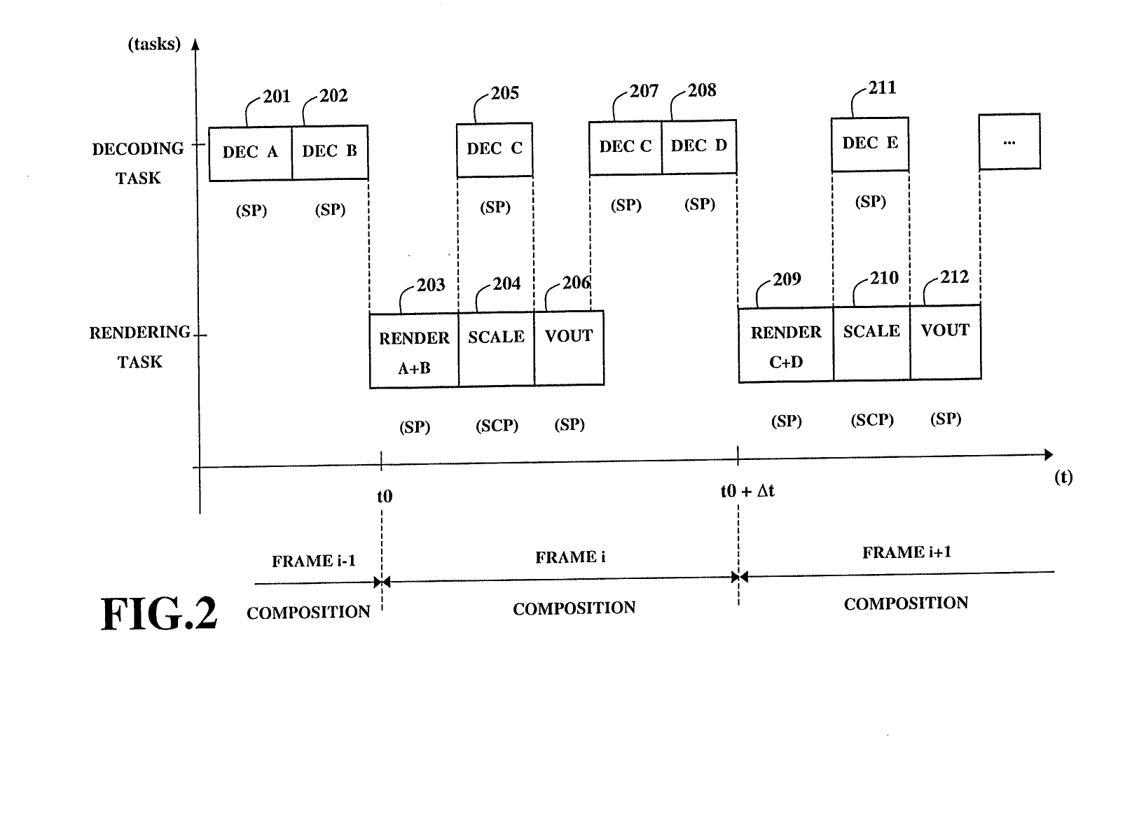

FIG. 2 depicts processing tasks synchronization between a signal processor and a signal co-processor as used in the invention.

The present invention relates to an improved method of composing a scene content from input video data streams encoded according to an object-oriented video standard.

The invention is described in the case of a video scene composed from input video streams encoded according to the MPEG-4 standard, but it will be apparent to those skilled in the art that the scope of this invention is not limited to this specific case, but also covers the case where a plurality of video streams have to be assembled, whether encoded according to the MPEG-4 standard or to other object-oriented video standards.

FIG. 1 depicts a block diagram corresponding to a video scene content composition method according to the invention. In this preferred described embodiment, the scene is composed from a background video and a foreground video, both contained in video streams encoded according to the MPEG-4 standard. The method of scene composition according to the invention comprises:

a decoding step 101 for decoding input MPEG-4 video streams 102 and 103, and generating decoded object frames 104 and 105, corresponding to the background and the foreground frames, respectively. There are as many decoders for generating object frames as there are input video streams.

a rendering step 113 for composing intermediate-composed frames in a composition buffer from these previously decoded object frames. This step includes a composition sub-step of a temporary frame no. i using an object frame no. i of the decoded background video and object frame no. i of the foreground video, i varying in an increasing order between 1 and the common number of frames contained in 104 and 105. The composition order is determined by the depth of each element to be rendered: the foreground video is first mapped in the composition buffer, then the foreground video is assembled in the background video, taking into consideration assembling parameters between said object frames such as the transparency coefficient between object frames. Rendering takes into account a user interaction 106, such as an indication of the desired foreground video position compared with the background video, said background video occupying, for example, the totality of the background area. Of course, other approaches may also be considered for assembling decoded object frames, such as the use of the BIFS (Binary Format for Scene) containing a scene graph description of object frames. The rendering step thus results in the composition of a current intermediate-composed frame stored in a composition buffer from the current object frame no. i referred to as 104 and the current object frame no. i referred to as 105. Then the rendering step will compose the future intermediate-composed frame no. i+1 from the future object frame no. i+1 of the decoded background video and the future object frame no. i+1 of the foreground video.

a scaling step 108 for enlarging the current intermediate-composed frame no. i previously rendered and contained in the composition buffer, said current frame being available at the rendering output step 107. This step enlarges rendered frames 107 along the horizontal and/or vertical axis so that the obtained frame 109 occupies a larger area in view of a full screen display 110. This scaling step allows to obtain a large frame format from a small frame format. To this end, pixels are duplicated horizontally and vertically as many times as the scaling factor value, not only on the luminance component but also on the chrominance components. Of course, alternative upscaling techniques may be used such as pixel interpolation-based techniques. For example, one may consider in a preferred embodiment that intermediate-composed frames 107 are obtained from CIF (Common Intermediate Format) object frames used as the background, and SQCIF (Sub Quarter Common Intermediate Format) object frames used as the foreground. By applying said scaling step to frames 107 with a scaling factor equal to two, the obtained frames 109 represent a QCIF overlay video format as the foreground with a CCIR-601 video format as the background, said CCIR-601 being required by most displays.

The method according to the invention also allows to turn off the scaling step 108. This possibility is realized with a switching step 112, which avoids any scaling operations on rendered frames 107. This switching step is controlled by an action 111 generated, for example, by an end user who does not want to have an enlarged video format on the display 110. To this end, the user may, for example, interact from a mouse or a keyboard.

With the insertion of the scaling step 108 in the composition process, this invention allows to obtain a large video frame on a display 110 from MPEG-4 objects of small size. As a consequence, lower computational resources are required for the decoding and the rendering steps, not only in terms of memory data manipulation but also in terms of CPU (Central Processing Units). This aspect of the invention then avoids processing latencies even with low processing means currently contained in consumer products, because a single scaling step is performed to enlarge all object frames contained in intermediate-composed frames.

FIG. 2 depicts how the composition processing steps, also called processing tasks, are synchronized when the scene composition method according to the invention is used, a horizontal time axis quantifying task duration. To take advantage of the complementary processing steps to be performed on MPEG-4 input video streams, the composition method is realized through two types of processes carried out by a signal processor (SP) and a signal co-processor (SCP), said processing means being well known by those skilled in the art for performing non-extensive data manipulation tasks and extensive data manipulation tasks, respectively. The invention proposes to use these devices in such a way that composition steps of the intermediate-composed frame no. i+1 available in 107 starts while the intermediate-composed frame no. i is being composed and rendered. To this end, the whole process, managed by a tasks manager, is split up into two different synchronized tasks: the decoding task and the rendering task, the decoding task being dedicated to the decoding (DEC) of input MPEG-4 object frames, and the rendering task being dedicated to the scene composition (RENDER), the scaling step (SCALE), and the presentation of the output frames to the video output (VOUT).

As an example, the intermediate-composed frame no. i is composed from object frames A and B, while the intermediate-composed frame no. i+1 is composed from object frames C and D. Explanations are given from time t0, assuming that in such initial conditions decoded frames A and B are available after decoding steps 201 and 202 performed by the signal processor during the composition of the frame i−1. First, object frames A and B are rendered in a composition buffer by the rendering step 203 using signal processor resources as described above for generating the intermediate-composed frame no. i. Then the scaling step 204 is applied to said intermediate-composed frame no. i in order to enlarge its frame format, and for generating output frame no. i. This operation is performed by the signal co-processor such that a minimum number of CPU cycles is necessary compared with a same operation performed by a signal processor. Simultaneously, the beginning of the scaling operation 204 starts the decoding 205 of object frame C used in the composition of intermediate-composed frame no. i+1. This decoding 205 is done by means of signal processor resources and continues until the scaling step 204 performed by the signal co-processor is finished. The scaling 204 being finished, the obtained output frame no. i is presented to the video output 206 by signal processor resources to be displayed. After that the output frame no. i is sent to the video out, and the decoding of object frames used for the composition of intermediate-composed frame no. i+1 is continued. Thus the decoding step 207 is performed with signal processor resources, said step 207 corresponding to the continuation of step 205 interrupted by step 206, if step 205 had not been completed yet This step 207 is followed by a decoding step 208 performed with a signal processor resources and delivering an object frame D. Note that in such a solution the decoding steps are performed in a sequential order by signal processor resources.

The synchronization between decoding and rendering tasks is managed by a semaphore mechanism, said semaphore corresponding to a flag successively incremented and decremented by different processing steps. In the preferred embodiment, after each decoding loop, as it is the case after steps 201 and 202, the semaphore is set indicating to the rendering step 203 that new object frames have to be rendered. When the rendering step 203 is finished, the semaphore is reset, which simultaneously launches the scaling step 204 and the decoding step 205. The scaling step is performed with an interruption.

To perform real-time video rendering, rendering tasks are called at a video frequency, i.e. with a period At equal to 1/25 second or 1/30 second according to the video standards PAL or NTSC. Using simultaneously signal processor and signal co-processor resources, the decoding of object frames C and D used for the composition of the intermediate-composed frame no. i+1 is started during the rendering process of the output frame no. i. In this way decoded object frames are ready to be rendered when the rendering step 209 is called by the task manager. Then the scaling step 210 is performed simultaneously with the decoding step 211, followed by the presentation step 212 leading to a display of the output frame no. i+1.

A similar process starts at time (t0+Δt) to render output frame no. i+1, said frame being obtained after a scaling step applied to the intermediate-composed frame composed from object frames decoded between times t0 and (t0+Δt), i.e. during the rendering of the output frame no. i.

A mechanism is also proposed whereby the number of decoding steps is limited to a given maximum value MAX_DEC during the scaling step of the output frame no. i. This mechanism counts the number CUR_DEC of successive decoding steps performed during the scaling step generating the output frame no. i, and stops the decoding when CUR_DEC reaches MAX_DEC. The decoding step then enters in an idle mode for a while, for example, until output frame no. i has been presented to a display.

Such a mechanism avoids a too high memory consumption during the rendering of frame no. i, which would cause too many successive decoding steps of object frames used in the rendering of the output frame no. i+1.

An improved method of composing a scene content from input video data streams encoded according to the MPEG-4 video standard has been described. This invention may also be used for scene composition from varied decoded MPEG-4 objects, such as images or binary shapes. The scaling step, dedicated to enlarging object frames, may also take different values according to the needed output frame format. The simultaneous use of signal processor resources and signal co-processor resources may also be applied to tasks other than object frame decoding, such as the analysis and the processing of user interactions.

Of course, all these aspects may take place in the present invention without departing from the scope and the pertinence of said invention.

This invention may be implemented in several manners, such as by means of wired electronic circuits, or alternatively by means of a set of instructions stored in a computer-readable medium, said instructions replacing at least part of said circuits and being executable under the control of a computer, a digital signal processor, or a digital signal co-processor in order to carry out the same functions as fulfilled in said replaced circuits. The invention then also relates to a computer-readable medium comprising a software module that includes computer-executable instructions for performing the steps, or some steps, of the method described above.

1. A method of composing a scene content from digital video data streams containing video objects, said method comprising a decoding step for generating decoded object frames from said digital video data streams, and a rendering step for composing intermediate-composed frames in a composition buffer from said decoded object frames, characterized in that said method also comprises a scaling step applied to said intermediate-composed frames for generating output frames constituting scene content.

2. A method of composing a scene content as claimed in claim 1, characterized in that it comprises:
a partitioning step for identifying non-extensive data manipulation steps,
a partitioning step for identifying extensive data manipulation steps, said method being designed to be executed by means of a signal processor and a signal co-processor which perform synchronized and parallel processing steps for creating simultaneously current and future output frames from said intermediate-composed frames, the signal processor being dedicated to said non-extensive data manipulation steps, and the signal co-processor being dedicated to said extensive data manipulation steps.

3. A method of composing a scene content as claimed in claim 2, characterized in that the scaling step of a current intermediate-composed frame is designed to be performed by the signal co-processor while the decoding step which generates decoded object frames used for the composition of the future intermediate-composed frame is being performed simultaneously by the signal processor.

4. A method of composing a scene content as claimed in claim 3, characterized in that during the scaling step, the decoding step is limited to decoding a maximum number of object frames used for the composition of future intermediate-composed frames.

5. A device for composing a scene content from digital video data streams containing video objects, said device comprising decoding means for providing decoded object frames from said digital video data streams, and rendering means for composing intermediate-composed frames in a composition buffer from said decoded object frames, characterized in that said device also comprises scaling means applied to said intermediate-composed frames for generating output frames constituting scene content.

6. A device for composing a scene content as claimed in claim 5, characterized in that it comprises separate processing means composed by a signal processor which is dedicated to non-extensive data manipulation tasks, and by a signal co-processor which is dedicated to extensive data manipulation tasks, said processing means being designed to execute synchronized and parallel calculations for creating simultaneously current and future output frames from said intermediate-composed frames.

7. A device for composing a scene content as claimed in claim 6, characterized in that the scaling means applied to a current intermediate-composed frame are designed to be implemented by the signal co-processor while the decoding means providing decoded object frames used for the composition of the future intermediate-composed frame are designed to be implemented simultaneously by the signal processor.

8. A device for composing a scene content as claimed in claim 7, characterized in that during the scaling step, the decoding means are limited to decoding a maximum number of object frames used for the composition of future intermediate-composed frames.

9. A set top box designed for composing a scene content from digital video data streams encoded according to the MPEG-4 standard and carrying out a method as claimed in claim 1.

10. A computer program product for a device for composing a scene content from decoded object frames, comprising a set of instructions which, when loaded into said device for composing, causes said device for composing to carry out the method as claimed in claim 1.
